(19) United States
(12) Patent Application Publication
(10) Pub. No.: US 2026/0249839 A1
(43) Pub. Date: Aug. 27, 2026

(54) Parking Assistance Method and Parking Assistance Device

(71) Applicant: Nissan Motor Co., Ltd., Yokohama-shi, Kanagawa (JP)

(72) Inventors: Muku Takeda, Kanagawa (JP); Yasuhiro Suzuki, Kanagawa (JP)

(21) Appl. No.: 19/159,547

(22) PCT Filed: Mar. 3, 2023
(86) PCT No.: PCT/JP2023/008120

§ 371 Date: Aug. 25, 2025

(51) Int. Cl. B60W 30/06; B60W 50/14; G06T 7/70; G06V 20/58

(52) U.S. Cl. CPC B60W 30/06; B60W 50/14; G06T 7/70; G06V 20/58; B60W 2420/403; B60W 2520/10; B60W 2554/4041; G06T 2207/20081; G06T 2207/30252; G06V 2201/07

(57) ABSTRACT

A parking assistance method includes: extracting a target object in surroundings of a target parking position from surrounding environment data of an own vehicle; storing the extracted target object in a storage device as a learned target object with the target parking position; and assisting, at a time of parking the own vehicle at the target parking position after storing the learned target object in the storage device, parking of the own vehicle at the target parking position, based on the learned target object. The parking assistance method, when length of an advancing travel section that is a section where the own vehicle travels in an advancing direction, within a data detection section that is a section where the own vehicle travels and acquires the surrounding environment data, is greater than or equal to a predetermined threshold value, stores the extracted target object as a learned target object.

### TECHNICAL FIELD

The present invention relates to a parking assistance method and a parking assistance device.

### BACKGROUND

JP 2022-551084 A described below describes a parking method for controlling a vehicle in accordance with a parking route stored in advance. In the parking method, a parking route is not stored when parking environment parameters when the parking route is stored do not satisfy preset environmental conditions.

### SUMMARY

In parking assistance in which a target object in surroundings of a target parking position is stored in conjunction with the target parking position in advance and parking of an own vehicle at the target parking position is assisted based on the stored target object, there is a risk that a user feels dissatisfied due to inability to perform the parking assistance even when the target parking position is stored unless the target object is stored along an appropriate parking route.

An object of the present invention is to avoid, in parking assistance in which a target object in surroundings of a target parking position is stored in conjunction with the target parking position in advance and parking of an own vehicle at the target parking position is assisted based on the stored target object, dissatisfaction of a user due to inability to perform the parking assistance in parking at the stored target parking position because of the target object not being stored along an appropriate parking route.

According to an aspect of the present invention, there is provided a parking assistance method for assisting parking of an own vehicle at a target parking position, the parking assistance method including: extracting a target object in surroundings of the target parking position from surrounding environment data acquired by detecting a surrounding environment of the own vehicle using a sensor of the own vehicle, and storing the extracted target object in a storage device as a learned target object in conjunction with the target parking position, in advance; and assisting, at a time of parking the own vehicle at the target parking position after storing the learned target object in the storage device, parking of the own vehicle at the target parking position, based on the learned target object, wherein the parking assistance method, when length of an advancing travel section, the advancing travel section being a section where the own vehicle travels in an advancing direction, within a data detection section, the data detection section being a section where the own vehicle travels and acquires the surrounding environment data, is greater than or equal to a predetermined threshold value, stores the extracted target object as a learned target object and, when length of the advancing travel section is not greater than or equal to the predetermined threshold value, does not store the extracted target object as the learned target object.

According to an aspect of the present invention, it is possible to avoid, in parking assistance in which a target object in surroundings of a target parking position is stored in conjunction with the target parking position in advance and parking of an own vehicle at the target parking position is assisted based on the stored target object, dissatisfaction of a user due to inability to perform the parking assistance in parking at the stored target parking position because of the target object not being stored along an appropriate parking route.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrative of a schematic configuration example of a parking assistance device of embodiments;

FIGS. 2A and 2B are schematic diagrams descriptive of parking assistance control;

FIG. 3 is an explanatory diagram of a parking assistance method of a first embodiment;

FIG. 4 is a flowchart of the parking assistance method of the first embodiment;

FIG. 5 is a block diagram of an example of a functional configuration of a controller in FIG. 1;

FIGS. 6A to 6C are explanatory diagrams of permission condition for permitting registration of learned target object data; and

FIG. 7 is a flowchart of a parking assistance method of a second embodiment.

### DETAILED DESCRIPTION

### First Embodiment

### Configuration

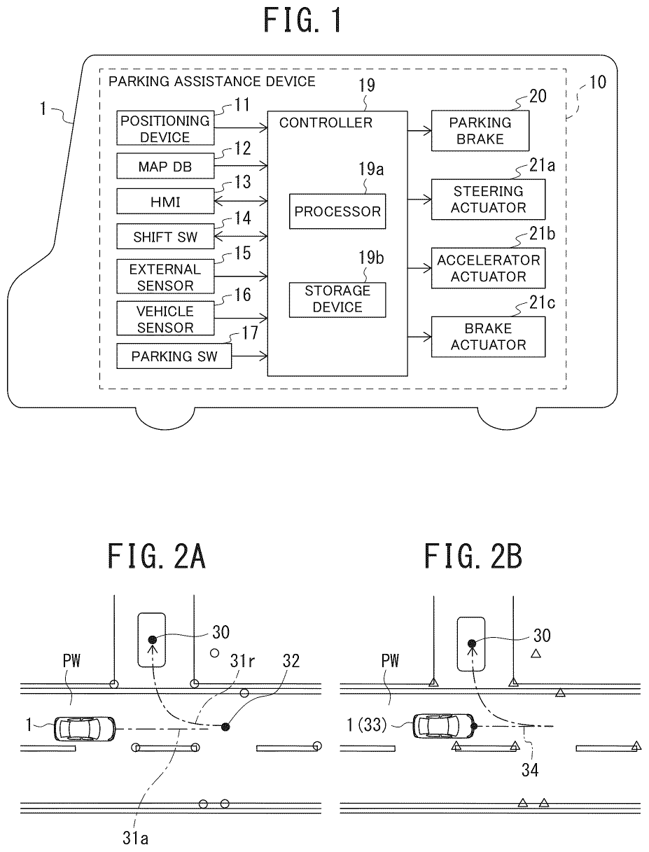

FIG. 1 is a diagram illustrative of a schematic configuration example of a parking assistance device of embodiments. An own vehicle 1 includes a parking assistance device 10 configured to assist parking of the own vehicle 1 at a target parking position. The parking assistance device 10 assists the own vehicle 1 in traveling along a target parking route from a current position of the own vehicle 1 to the target parking position. For example, the driving assistance device 10 may perform autonomous driving to control the own vehicle 1 to travel to the target parking position along the target parking route of the own vehicle 1. The autonomous driving to control the own vehicle 1 to travel to the target parking position along the target parking route means control to automatically perform all or a portion of travel along the target parking route of the own vehicle 1 by controlling all or some of a steering angle, driving force, and braking force of the own vehicle 1. Alternatively, the parking assistance device 10 may assist a user on board the own vehicle 1 (for example, a passenger such as a driver) in parking the own vehicle 1 by displaying the target parking route and the current position of the own vehicle 1 on a display device that the user can visually recognize.

A positioning device 11 measures the current position of the own vehicle 1. The positioning device 11 includes, for example, a global navigation satellite system (GNSS) receiver. In a map database (map DB) 12, map data are stored. The map data stored in the map database 12 may be, for example, map data for navigation or high-definition map data that is suitable as a map for autonomous driving.

Human-machine interfaces (HMIs) 13 are interface devices that transfer information between the parking assistance device 10 and the user. For example, the HMIs 13 may include a display device that the user can visually recognize, as an interface presenting visual information to the user. In addition, the HMIs 13 may include a speaker or a buzzer as an interface presenting auditory information to the user. In addition, the HMIs 13 may include an interface (such as a touch panel, a button, a switch, a lever, a dial, and a keyboard) accepting an operation input from the user.

A shift switch (shift SW) 14 is a switch for the driver or the parking assistance device 10 to switch a shift position of the own vehicle 1.

External sensors 15 detect a surrounding environment of the own vehicle 1 in a predetermined distance range from the own vehicle 1 and generates surrounding environment data that are data indicating a detection result of the surrounding environment. For example, the external sensors 15 may detect, as the surrounding environment of the own vehicle 1, a relative position between an object existing in surroundings of the own vehicle 1 and the own vehicle 1, distance between the own vehicle 1 and the object, and a direction in which the object exists. For example, the external sensors 15 may include a camera to capture an image depicting the surrounding environment of the own vehicle 1 and generate a surrounding image acquired by capturing the surroundings of the own vehicle 1 as the surrounding environment data. In addition, the external sensors 15 may include a ranging device, such as a laser range finder, a radar, a light detection and ranging (LiDAR), and a sonar, and generate ranging data in the surroundings of the own vehicle 1 measured by the ranging device, as the surrounding environment data.

Vehicle sensors 16 detect various information (vehicle information) about the own vehicle 1. For example, the vehicle sensors 16 may include wheel speed sensors to detect rotational speeds of wheels of the own vehicle 1, a vehicle speed sensor to detect traveling speed of the own vehicle 1, a triaxial acceleration sensor to detect acceleration (including deceleration) in three axial directions of the own vehicle 1, and a sensor to detect a steering angle of a steering wheel or a steered angle of steered wheels.

A parking switch (parking SW) 17 is a switch to start parking assistance control performed by the parking assistance device 10.

A controller 19 is an electronic control unit that performs parking assistance control of the own vehicle 1. The controller 19 includes a processor 19a and a peripheral component, such as a storage device 19b. The processor 19a may be, for example, a CPU or an MPU. The storage device 19b may include a semiconductor storage device, a magnetic storage device, an optical storage device, or the like. Functions of the controller 19, which will be described below, are achieved by, for example, the processor 19a executing computer programs stored in the storage device 19b.

A parking brake 20 generates friction braking force on the wheels of the own vehicle 1 in accordance with operation by the user or a control signal from the controller 19.

A steering actuator 21a controls steering direction and the amount of steering of a steering mechanism of the own vehicle 1 in accordance with a control signal from the controller 19. An accelerator actuator 21b controls accelerator opening of a drive device, which is an engine or a drive motor, in accordance with a control signal from the controller 19. A brake actuator 21c causes a braking device to operate in accordance with a control signal from the controller 19.

Next, the parking assistance control performed by the controller 19 will be described. FIGS. 2A and 2B are schematic diagrams descriptive of the parking assistance control. When the parking assistance control is used, a target parking position 30 at which the own vehicle 1 is to be parked is registered in the parking assistance device 10 in advance. Specifically, a target object existing in surroundings of the target parking position 30 is extracted and stored (registered) in the storage device 19b in advance. In the following description, a target object in the surroundings of the target parking position 30 to be stored in the storage device 19b is referred to as “learned target object”. In FIG. 2A, circular marks schematically represent learned target objects. When the target parking position 30 is to be registered in the parking assistance device 10, the user performs an operation to instruct registration of the target parking position 30 (hereinafter, sometimes referred to as “registration operation”). For example, the registration operation may be an operation to switch the shift position to a parking range or manipulation of a parking switch 17 when the shift position is in the parking range.

For example, the controller 19 stores a learned target object in the storage device 19b when the user parks the own vehicle 1 at the target parking position 30 by manual driving. In the example in FIG. 2A, when the own vehicle 1 is to be parked at the target parking position 30, the controller 19 causes the own vehicle 1 to travel in the advancing direction along a parking route 31a in a pathway PW in which the own vehicle 1 travels towards an entrance of the target parking position 30, performs maneuvering back and forth of the own vehicle 1 and changes the shift position of the own vehicle 1 from an advancing travel position (such as a drive range or a brake range) to a reverse travel position at a maneuvering point 32, and subsequently causes the own vehicle 1 to travel in the reverse direction along a parking route 31r and travel to the target parking position 30. Note that “maneuvering back and forth” refers to operation of switching the shift position of a vehicle between the advancing travel position and the reverse travel position.

For example, the controller 19 extracts a target object in the surroundings of the target parking position 30 from the surrounding environment data acquired by detecting the surrounding environment of the own vehicle 1 using the external sensors 15 and stores the extracted target object as a learned target object. For example, the controller 19 may detect a target object from a surrounding image that is obtained by capturing the surroundings of the own vehicle 1 by the camera. For example, the controller 19 may detect, as a target object, an edge point where luminance changes between adjacent pixels by a predetermined amount or more or a point having a characteristic shape (a feature point), such as an edge or a corner of a target object like a pavement marking, a road boundary, an obstacle, or the like, in the captured image obtained by capturing the surroundings by the camera.

The controller 19 stores learned target object data relating to a learned target object in the storage device 19b. For example, the learned target object data may include data representing a feature amount of a learned target object (hereinafter, referred to as “feature amount data”) and data representing a relative positional relationship between the target parking position 30 and the learned target object (hereinafter, referred to as “relative position data”). The controller 19 may store, for example, a relative position of a learned target object with reference to the target parking position 30 as the relative position data. The controller 19 may store coordinates of a learned target object and the target parking position 30 in a coordinate system with a fixed point as a reference point (hereinafter, referred to as “map coordinate system”).

FIG. 2B is an explanatory diagram of an example of processing performed when parking assistance is performed. The controller 19 starts the parking assistance control of the own vehicle 1 when a user operation instructing start of the parking assistance control of the own vehicle 1 is performed (hereinafter, sometimes referred to as “starting operation”). The starting operation may be an operation of the parking switch 17 by the user. The controller 19 may automatically start the parking assistance control when the own vehicle 1 approaches the registered target parking position 30.

When the parking assistance control is started, the controller 19 extracts a target object in the surroundings of the own vehicle 1 by the external sensors 15. In the following description, a target object in the surroundings of the own vehicle 1 that is extracted when the parking assistance is performed is referred to as “surrounding target object”. In FIG. 2B, triangular marks represent surrounding target objects. The controller 19 detects the target parking position 30 by matching a learned target object and a surrounding target object with each other and associating the same feature points with each other. For example, the controller 19 calculates a relative position of the own vehicle 1 with respect to the target parking position 30, based on a relative positional relationship between a surrounding target object detected when the parking assistance is performed and the own vehicle 1 and a relative positional relationship between a learned target object associated with the surrounding target object and the target parking position 30.

For example, the controller 19 calculates a position of the target parking position 30 in a coordinate system with reference to the current position of the own vehicle 1 (hereinafter, referred to as “vehicle coordinate system”). Note that when coordinates of the learned target object and the target parking position 30 in the map coordinate system are stored in the storage device 19b, the controller 19 may convert the coordinates of the target parking position 30 in the map coordinate system to coordinates in the vehicle coordinate system, based on the position of the surrounding target object detected when the parking assistance is performed and the position of the learned target object in the map coordinate system. The controller 19 may calculate the self-position of the own vehicle 1 in the map coordinate system, based on the position of the surrounding target object detected when the parking assistance is performed and the position of the learned target object in the map coordinate system, and calculate the relative position of the own vehicle 1 with respect to the target parking position 30 from a difference between the coordinates of the own vehicle 1 and the coordinates of the target parking position 30 in the map coordinate system.

The controller 19 calculates a target parking route 34 starting from a current position 33 of the own vehicle 1 and reaching the target parking position 30, based on the relative position of the own vehicle 1 with respect to the target parking position 30. The controller 19 performs the parking assistance control of the own vehicle 1, based on the calculated target parking route 34.

In such a parking assistance method, when a learned target object (circular mark) located along an appropriate parking route cannot be stored in a scene where a learned target object is stored (FIG. 2A), in a scene where the parking assistance is performed (FIG. 2B), an overlapping range between a region where surrounding target objects (triangular marks) detected in the surroundings of the own vehicle 1 are distributed and a region where learned target objects are distributed becomes small and there is a risk that it becomes difficult to match a sufficient number of surrounding target objects and learned target objects with each other.

For example, when in a case where, as illustrated in FIG. 2A, learned target objects located along parking routes 31a and 31r are stored, a section 31a where the own vehicle 1 travels in the advancing direction along the pathway PW to the maneuvering point 32 is short, it becomes difficult to detect a surrounding target object that can be matched with a learned target object until the own vehicle 1 comes close to a vicinity of the target parking position 30.

As a result, there is a risk that the user feels dissatisfied since difficulty in identifying the relative position of the own vehicle 1 with respect to the target parking position 30 occurs and therefore the parking assistance to the target parking position 30 cannot be performed even though the target parking position 30 is registered in the storage device 19b.

Accordingly, in the parking assistance method of a first embodiment, the storage of a learned target object is permitted only when length of an advancing travel section that is a section where the own vehicle 1 traveled in the advancing direction within a section where the own vehicle 1 traveled while acquiring surrounding environment data for extraction of a learned target object (hereinafter, sometimes referred to as “data detection section”) is greater than or equal to a predetermined threshold value. For example, the predetermined threshold value may be set to a fixed value, such as half the length of the data detection section or 20 meters.

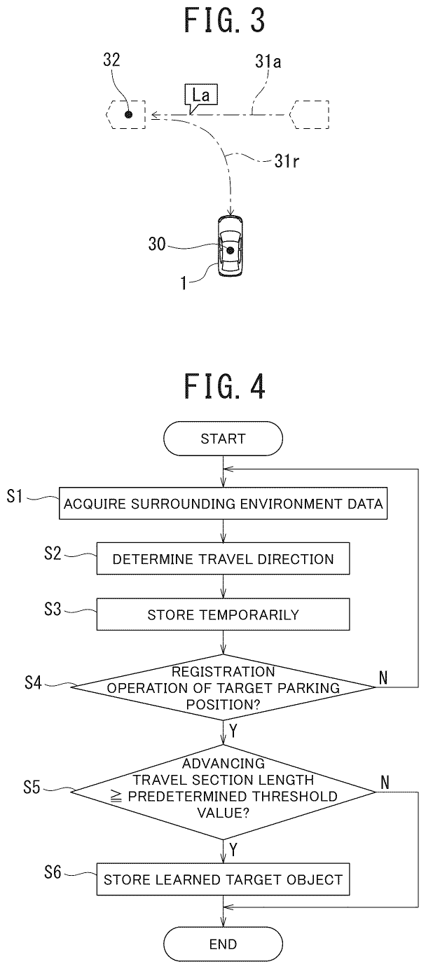

FIG. 3 is an explanatory diagram of the parking assistance method of the first embodiment. In the example in FIG. 3, when detecting a learned target object and storing the detected learned target object in the storage device 19b, the controller 19 acquires surrounding environment data and extracts a learned target object in the advancing travel section 31a where the own vehicle 1 is caused to travel in the advancing direction along the parking route and reach the maneuvering point 32 and the reverse travel section 31r where the own vehicle 1 is caused to travel in the reverse direction from the maneuvering point 32 along the parking route and reach the target parking position 30 (that is, the data detection section includes the advancing travel section 31a and the reverse travel section 31r).

The controller 19 stores a target object extracted from the surrounding environment data acquired in the advancing travel section 31a and the reverse travel section 31r in the storage device 19b as a learned target object when length La of the advancing travel section 31a is greater than or equal to a predetermined threshold value Lth. Conversely, when the length La of the advancing travel section 31a is not greater than or equal to the predetermined threshold value Lth, the controller 19 does not store a target object extracted from the surrounding environment data acquired in the advancing travel section 31a and the reverse travel section 31r in the storage device 19b as a learned target object.

Because of this configuration, a learned target object existing along a parking route along which the own vehicle 1 traveled in the advancing direction in the pathway PW toward the target parking position 30 before the own vehicle 1 reached the vicinity of the target parking position 30 can be stored.

Thus, in the scene where the parking assistance is performed (FIG. 2B), it is possible to secure a sufficient overlapping range between the region where surrounding target objects (triangular marks) detected in the surroundings of the own vehicle 1 are distributed and the region where learned target objects (circular marks) are distributed before the own vehicle 1 reaches the vicinity of the target parking position 30. As a result, since it is possible to prevent identification of the relative position of the own vehicle 1 with respect to the target parking position 30 from becoming difficult, the parking assistance to the target parking position is facilitated, and dissatisfaction of the user with the inability to perform the parking assistance despite that the target parking position is stored can be avoided. Note that as the lengths of the data detection section and the advancing travel section 31a, travel distance that is distance that the own vehicle 1 traveled may be used or travel time that is time that the own vehicle 1 took to travel may be used.

FIG. 4 is a flowchart when the target parking position 30 is registered in the parking assistance device 10 in advance in the parking assistance method of the first embodiment.

In step S1, the controller 19 acquires surrounding environment data for extraction of a learned target object from the external sensors 15 when the user parks the own vehicle 1 at the target parking position 30 by manual driving. In step S2, the controller 19 determines a current travel direction of the own vehicle 1. In step S3, the controller 19 extracts a target object from the surrounding environment data acquired in step S1 and temporarily stores the extracted target object in a buffer.

In step S4, the controller 19 determines whether or not a registration operation instructing registration of the target parking position 30 has been performed. When no registration operation has been performed (step S4: N), the process returns to step S1. When a registration operation is performed (step S4: Y), the process proceeds to step S5. In step S5, when length of an advancing travel section where the own vehicle 1 traveled in the advancing direction within a data detection section where the own vehicle 1 traveled while acquiring the surrounding environment data is not greater than or equal to a predetermined threshold value Lth (step S5: N), the controller 19 terminates the process. In this case, no learned target object is stored in the storage device 19b. When the length of the advancing travel section is greater than or equal to the predetermined threshold value Lth (step S5: Y), the process proceeds to step S6. In step S6, the controller 19 stores the temporarily stored target objects in the storage device 19b as a learned target object. Subsequently, the process terminates.

### Second Embodiment

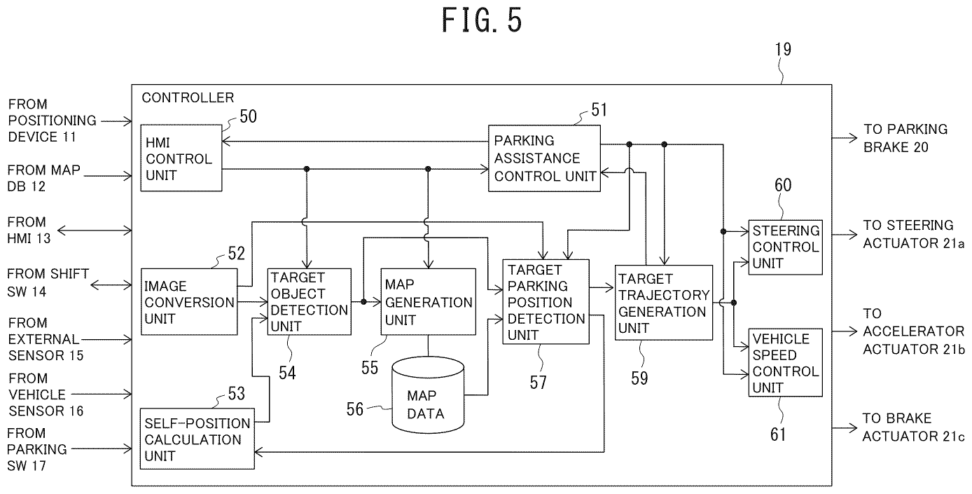

FIG. 5 is a block diagram of an example of a functional configuration of a controller 19. When an HMI control unit 50 detects a registration operation by a user, the HMI control unit 50 outputs a map generation command to cause learned target object data to be stored in a storage device 19b to a map generation unit 55.

An image conversion unit 52 converts a captured image captured by a camera to an overhead view image that is an image viewed from a virtual viewpoint directly above an own vehicle 1. The overhead view image is an example of “surrounding environment data” described in the claims. The image conversion unit 52 converts a captured image to an overhead view image at a predetermined interval I. For example, the image conversion unit 52 may generate an overhead view image every time the own vehicle 1 travels a predetermined distance (for example, 1 m). The image conversion unit 52 may generate an overhead view image every time the own vehicle 1 travels for a predetermined time (for example, for 1 second). Each of overhead view images acquired when the own vehicle 1 is at different positions in this way is referred to as “frame”, and the number of overhead view images is sometimes referred to as “the number of frames”. A product of the number of frames and the predetermined interval I is equal to travel distance or travel time required to generate overhead view images of the number of frames.

A self-position calculation unit 53 calculates a current position of the own vehicle 1 in a map coordinate system as a self-position by odometry (for example, dead reckoning) based on vehicle information output from vehicle sensors 16. In addition, the self-position calculation unit 53 detects a travel direction of the own vehicle 1. For example, the self-position calculation unit 53 may detect the travel direction of the own vehicle 1, based on a shift position of a shift switch 14 and a detection result of a vehicle speed sensor.

A target object detection unit 54 detects a target object from an overhead view image output from the image conversion unit 52. The target object detection unit 54 may detect a position of a feature point of a target object and an image feature amount of the feature point as a target object. The target object detection unit 54 outputs the detected position and image feature amount of the feature point to the map generation unit 55 and a target parking position detection unit 57 as target object data. In addition, the target object detection unit 54 outputs the self-position acquired from the self-position calculation unit 53 in synchronization with the detection of the target object to the map generation unit 55 and the target parking position detection unit 57.

The map generation unit 55 temporarily accumulates, in a buffer, target object data and the self-position data output from the target object detection unit 54 while the own vehicle 1 is traveling along a travel route of the own vehicle 1. When the number of frames the target object data in which are stored in the buffer reaches a first upper limit number Nfu1, the map generation unit 55 deletes target object data detected from the oldest frame and accumulates target object data detected from a new frame.

In addition, the map generation unit 55 categorizes target object data output from the target object detection unit 54 into target object data detected from a frame acquired in the advancing travel section 31a and target object data detected from a frame acquired in the reverse travel section 31r.

In the following description, a frame acquired in the advancing travel section 31a is referred to as “advancing travel section frame”, target object data detected from an advancing travel section frame is referred to as “advancing travel section data”, a frame acquired in the reverse travel section 31r is referred to as “reverse travel section frame”, and target object data detected from a reverse travel section frame is referred to as “reverse travel section data”, in some cases. When the number of advancing travel section frames the target object data in which are stored in the buffer reaches a second upper limit number Nfu2 that is smaller than the first upper limit number Nfu1, the map generation unit 55 deletes the oldest advancing travel section data from the buffer and accumulates new advancing travel section data.

When the map generation unit 55 receives a map generation command from the HMI control unit 50 (that is, when registration processing of a target parking position 30 is started), the map generation unit 55 performs registration possibility determination processing of learned target object data. In the registration possibility determination processing, the map generation unit 55 determines whether or not a permission condition for permitting registration of learned target object data in the storage device 19b (hereinafter, referred to as “permission condition”) is satisfied, based on the number of advancing travel section frames the target object data in which are accumulated in the buffer and the number of times of maneuvering back and forth in the data detection section. That is, the map generation unit 55 determines whether or not the permission condition is satisfied, based on length of the advancing travel section 31a the target object data in which are temporarily accumulated in the buffer and the number of times of maneuvering back and forth. When the permission condition is satisfied, the map generation unit 55 generates learned target object data, based on the target object data and the self-position data temporarily accumulated in the buffer, and stores the generated learned target object data in the storage device 19b as map data 56. When the permission condition is not satisfied, the map generation unit 55 does not store learned target object data in the storage device 19b (that is, does not permit storage of learned target object data in the storage device 19b).

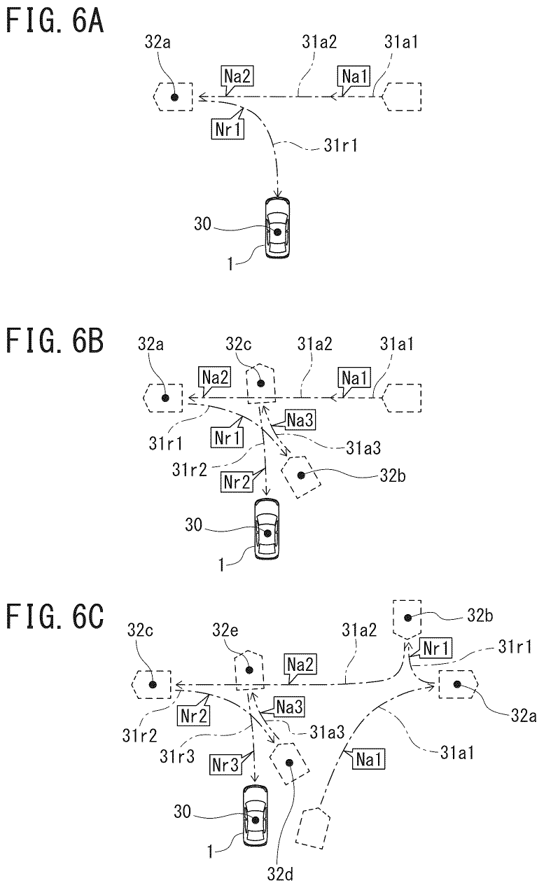

FIGS. 6A to 6C are explanatory diagrams of the permission condition. Reference signs 31a1 to 31a3 denote advancing travel sections included in the data detection section, reference signs Na1 to Na3 denote the numbers of frames detected in the advancing travel sections 31a1 to 31a3, respectively, reference signs 31r1 to 31r3 denote reverse travel sections included in the data detection section, reference signs Nr1 to Nr3 denote the numbers of frames detected in the reverse travel sections 31r1 to 31r3, respectively, and reference signs 32a to 32e denote maneuvering points at which the own vehicle 1 performed maneuvering back and forth in the data detection section. In the following description, the advancing travel sections 31a1 to 31a3 are collectively referred to as “advancing travel sections 31a”, the numbers of frames in the advancing travel sections 31a are collectively referred to as “the numbers Na of frames”, the reverse travel sections 31r1 to 31r3 are collectively referred to as “reverse travel sections 31r”, the numbers of frames in the reverse travel sections 31r are collectively referred to as “the numbers Nr of frames”, and the maneuvering points 32a to 32e are collectively referred to as “maneuvering points 32”, in some cases.

FIG. 6A illustrates a parking route along which the own vehicle 1 traveled in the advancing direction through the advancing travel section 31a1 and went on to travel in the advancing direction through the advancing travel section 31a2, subsequently performed maneuvering back and forth at the maneuvering point 32a and traveled in the reverse direction through the reverse travel section 31r1, and reached the target parking position 31. As described above, when the number of frames the target object data in which are temporarily stored in the buffer reaches the first upper limit number Nfu1, the map generation unit 55 deletes target object data detected from the oldest frame from the buffer when accumulating target object data detected from a new frame. Therefore, total length of the advancing travel sections 31a1 and 31a2 and the reverse travel section 31r1 the target object data in which are to be stored as learned target object data is limited to less than or equal to a predetermined length matching the first upper limit number Nfu1 (that is, Na1+Na2+Nr1≤Nfu1). The predetermined length matching the first upper limit number Nfu1 is an example of “first predetermined length” described in the claims.

In addition, when the number of advancing travel section frames the advancing travel section data in which are stored in the buffer reaches the second upper limit number Nfu2, the map generation unit 55 deletes the oldest advancing travel section data from the buffer when accumulating new advancing travel section data. Therefore, when the number Na2 of frames in the advancing travel section 31a2 where the own vehicle 1 has traveled after the advancing travel section 31a1 reaches the second upper limit number Nfu2, the map generation unit 55 deletes the advancing travel section data acquired in the advancing travel section 31a1 from the buffer. Thus, the advancing travel section data acquired in the advancing travel section 31a1 are not stored as learned target object data. That is, the total length of the advancing travel sections 31a from which a target object to be stored as learned target object data is extracted is limited to less than or equal to a predetermined length matching the second upper limit number Nfu2 (that is, Na≤Nfu2). The predetermined length matching the second upper limit number Nfu2 is an example of “second predetermined length” described in the claims.

For example, the map generation unit 55 may determine that the permission condition is satisfied when the following condition (C1) is satisfied.

(C1) The total of the numbers Na of frames the advancing travel section data in which are accumulated in the buffer within the advancing travel sections 31a is greater than or equal to a predetermined threshold value Nth1 (that is, the total length of the advancing travel sections 31a within the data detection section is greater than or equal to a threshold value).

In addition, for example, the map generation unit 55 may determine that the permission condition is satisfied when both the above condition (C1) and the following condition (C2) are satisfied.

(C2) Vehicle speed of the own vehicle 1 in the data detection section is less than or equal to a predetermined speed.

FIG. 6B illustrates a parking route along which the own vehicle 1 traveled in the advancing direction through the advancing travel section 31a1 and went on to travel in the advancing direction through the advancing travel section 31a2, subsequently performed maneuvering back and forth at the maneuvering point 32a and traveled in the reverse direction through the reverse travel section 31r1, subsequently performed maneuvering back and forth at the maneuvering point 32b and traveled in the advancing direction through the advancing travel section 31a3, subsequently performed maneuvering back and forth at the maneuvering point 32c and traveled in the reverse direction through the reverse travel section 31r2, and reached the target parking position 31.

For example, the map generation unit 55 may determine that the permission condition is satisfied when both the above condition (C1) and the following condition (C3) are satisfied or when all of the above conditions (C1) and (C2) and the following condition (C3) are satisfied.

(C3) The number Na2 of frames the advancing travel section data in which remain in the buffer within the advancing travel section 31a2 of the advancing travel sections 31a1 and 31a2 before the first maneuvering point 32a is greater than or equal to a predetermined threshold value Nth2 (that is, length of a section where frames from which a target object that can be stored as a learned target object is extracted are detected within the advancing travel sections 31a1 and 31a2 before the first maneuvering point 32a is greater than or equal to a predetermined length).

For example, when the total of the numbers of frames in sections after the first maneuvering point 32a (in the example of FIG. 6B, Nr1+Na3+Nr2) becomes larger than a difference obtained by subtracting the predetermined threshold value Nth2 from the second upper limit number Nfu2 (Nfu2−Nth2), the number of frames the advancing travel section data in which remain in the buffer as a target object to be stored as a learned target object within the advancing travel section 31a2 becomes smaller than the predetermined threshold value Nth2. In this case, the condition (C3) is not satisfied.

Note that the predetermined threshold value Nth2 may be the same as the predetermined threshold value Nth1 or may be smaller than the predetermined threshold value Nth1.

FIG. 6C illustrates a parking route along which the own vehicle 1 traveled in the advancing direction through the advancing travel section 31a1, subsequently performed maneuvering back and forth at the maneuvering point 32a and traveled in the reverse direction through the reverse travel section 31r1, subsequently performed maneuvering back and forth at the maneuvering point 32b and traveled in the advancing direction through the advancing travel section 31a2, subsequently performed maneuvering back and forth at the maneuvering point 32c and traveled in the reverse direction through the reverse travel section 31r2, subsequently performed maneuvering back and forth at the maneuvering point 32d and traveled in the advancing direction through the advancing travel section 31a3, subsequently performed maneuvering back and forth at the maneuvering point 32e and traveled in the reverse direction through the reverse travel section 31r3, and reached the target parking position 31.

For example, the map generation unit 55 may determine that the permission condition is satisfied when both the above condition (C1) and the following condition (C4) are satisfied, when all of the above conditions (C1) and (C2) and the following condition (C4) are satisfied, or when all of the above conditions (C1) to (C3) and the following condition (C4) are satisfied.

(C4) The number of times that the own vehicle 1 performs maneuvering back and forth in the data detection section is less than or equal to a predetermined number Cc of times.

For example, when the predetermined number Cc of times is set to 3, in the example of the parking route in FIG. 6C, the condition (C4) is not satisfied since the number of maneuvering points 32a to 32e is 5 (the number of times of maneuvering back and forth is “5”).

Note that the predetermined threshold value Nth1 may be set to different values between a case of right-angle parking where the own vehicle 1 is parked at a right angle with respect to the travel direction of the pathway PW in which the own vehicle 1 travels towards the target parking position 30 and a case of parallel parking where the own vehicle 1 is parked in parallel with the travel direction of the pathway PW. For example, since in the case of parallel parking, the advancing travel section 31a is generally likely to be shorter than in the case of right-angle parking, by setting a smaller predetermined threshold value Nth1 than in the case of right-angle parking, it is possible to prevent the storage of learned target object data from becoming difficult to be permitted. Likewise, the predetermined number Cc of times may be set to different values between the case of right-angle parking and the case of parallel parking. For example, in the case of parallel parking, a larger predetermined number Cc of times than in the case of right-angle parking may be set.

FIG. 5 is now referred to. When determining that the permission condition is satisfied, the map generation unit 55 generates learned target object data. For example, the map generation unit 55 acquires target object data and the self-position of the own vehicle 1 in the map coordinate system that is synchronous with the target object data, which are temporarily stored in the buffer. In addition, the map generation unit 55 acquires position information of the target parking position 30 in the map coordinate system. For example, the map generation unit 55 may acquire a self-position that the self-position calculation unit 53 calculates when the own vehicle 1 is positioned at the target parking position 30, as the position information of the target parking position 30.

The map generation unit 55 generates relative position data, based on a position of a feature point included in the target object data, position information of the own vehicle 1 synchronous with the position of the feature point, and position information of the target parking position 30. The map generation unit 55 acquires feature amount data from the target object data stored in the buffer. The map generation unit 55 generates learned target object data including the above-described relative position data and feature amount data and stores the generated learned target object data in the storage device 19b as the map data 56.

In contrast, when determining that the permission condition is not satisfied, the map generation unit 55 does not store the learned target object data in the storage device 19b. In this case, the HMI control unit 50 may notify the user of the own vehicle 1 (for example, a passenger) that the learned target object data are not registered. For example, the HMI control unit 50 may display, on a display device in HMIs 13, visual information to the effect that the learned target object data are not registered. In addition, the HMI control unit 50 may output auditory information to the effect that the learned target object data are not registered.

When the HMI control unit 50 detects a starting operation of parking assistance control performed by the user, the HMI control unit 50 outputs a control start command to start the parking assistance control to assist parking to a target parking position, to a parking assistance control unit 51.

When the parking assistance control unit 51 receives a control start command from the HMI control unit 50, the parking assistance control unit 51 determines whether or not the current position of the own vehicle 1 is in a vicinity of the registered target parking candidate 30. When the current position of the own vehicle 1 is in the vicinity of the registered target parking space 30, the parking assistance control unit 51 executes the parking assistance control. The parking assistance control unit 51 may automatically start the parking assistance control when the own vehicle 1 approaches the registered target parking position 30.

When the parking assistance control unit 51 starts the parking assistance control, the parking assistance control unit 51 outputs a parking position calculation command to the target parking position detection unit 57. When receiving a parking position calculation command, the target parking position detection unit 57 receives target object data output from the target object detection unit 54 as target object data of a surrounding target object and also receives the self-position of the own vehicle 1 in the map coordinate system in synchronization with the reception of the target object data.

The target parking position detection unit 57 detects the target parking position 30 by matching a learned target object and a surrounding target object with each other and associating the same feature points with each other. That is, the target parking position detection unit 57 determines whether or not the target parking position 30 can be detected, based on whether or not matching between the learned target object and the surrounding target object succeeds. When the matching succeeds (that is, when the target parking position 30 is detected), the target parking position detection unit 57 calculates a relative position of the own vehicle 1 with respect to the target parking position 30, based on a relative positional relationship between a surrounding target object and the own vehicle 1 and a relative positional relationship between a learned target object associated with the surrounding target object and the target parking position 30.

A target trajectory generation unit 59 calculates a target parking route starting from the current position of the own vehicle 1 and reaching the target parking position 30 in the vehicle coordinate system. The target trajectory generation unit 59 calculates a target vehicle speed profile that is a target value of vehicle speed of the own vehicle 1 on the target parking route. A steering control unit 60 controls a steering actuator 21a in such a way that the own vehicle 1 travels along the target parking route. A vehicle speed control unit 61 controls an accelerator actuator 21b and a brake actuator 21c in such a way that the vehicle speed of the own vehicle 1 changes in accordance with the target vehicle speed profile.

When the own vehicle 1 reaches the target parking position 30 and the parking assistance control is completed, the parking assistance control unit 51 causes a parking brake 20 to operate and switches the shift position to a parking range.

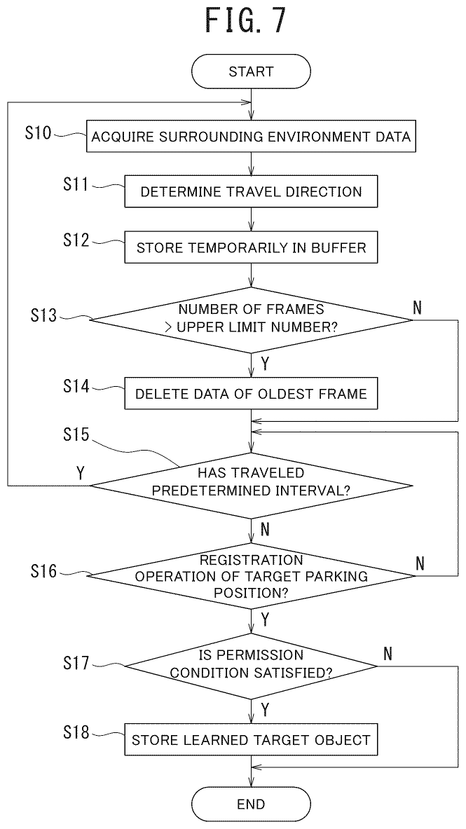

FIG. 7 is a flowchart of a parking assistance method of a second embodiment. In step S10, the image conversion unit 52 of the controller 19 acquires a captured image captured by a camera as surrounding environment data when the user parks the own vehicle 1 at a target parking position 30 by manual driving. In step S11, the self-position calculation unit 53 determines a current travel direction of the own vehicle 1. In step S12, the target object detection unit 54 detects a target object from an overhead view image output from the image conversion unit 52. The map generation unit 55 temporarily stores target object data of the target object detected by the target object detection unit 54 in the buffer. In step S13, the map generation unit 55 determines whether or not the number of frames the target object data in which are temporarily accumulated in the buffer has exceeded the first upper limit number Nfu1. When the number of frames has not exceeded the first upper limit number Nfu1 (step S13: N), the process proceeds to step S15. When the number of frames exceeds the first upper limit number Nfu1 (step S13: Y), the process proceeds to step S14. In step S14, the map generation unit 55 deletes target object data detected from the oldest frame from the buffer. Subsequently, the process proceeds to step S15.

In step S15, the map generation unit 55 determines whether or not the own vehicle 1 has traveled by a predetermined interval I. When the own vehicle 1 has traveled by the predetermined interval I (step S15: Y), the process returns to step S10. When the own vehicle 1 has not traveled by the predetermined interval I (step S15: N), the process proceeds to step S16. In step S16, the HMI control unit 50 determines whether or not the HMI control unit 50 has detected a registration operation of the target parking position. When the HMI control unit 50 has not detected the registration operation (step S16: N), the process returns to step S15. When the HMI control unit 50 detects the registration operation (step S16: Y), the process proceeds to step S17.

In step S17, the map generation unit 55 determines whether the permission condition is satisfied. When the permission condition is not satisfied (step S17: N), the process terminates without storing learned target object data in the storage device 19b. When the permission condition is satisfied (step S17: Y), the process proceeds to step S18. In step S18, the map generation unit 55 generates learned target object data, based on the target object data and the self-position data temporarily accumulated in the buffer, and stores the generated learned target object data in the storage device 19b. Subsequently, the process terminates.

### Variations

(1) Although in the above-described first embodiment, an example in which a target object extracted from surrounding environment data is temporarily stored in the buffer is described, the present invention is not limited to such a specific example. For example, it may be configured such that the surrounding environment data, in place of the target object, are temporarily stored in the buffer and after the registration operation is performed, the target object is extracted from the surrounding environment data stored in the buffer. Likewise, although in the second embodiment, an example in which target object data extracted from an overhead view image are temporarily stored in the buffer is described, it may be configured such that the overhead view image, in place of the target object data, is temporarily stored in the buffer and after the registration operation is performed, the target object data are extracted from the overhead view image stored in the buffer.
(2) Although in the above-described embodiments, a target object extracted from surrounding environment data detected in a section where travel distance or travel time from a target parking position is less than or equal to a first predetermined length within the data detection section is stored as a learned target object, the present invention is not limited thereto. A target object extracted from surrounding environment data detected in a section where travel distance or travel time from the target parking position is longer than the first predetermined length may be stored as a learned target object. In this case, the map generation unit 55 stores, as a learned target object, a target object extracted when length of an advancing travel section that is a section where travel distance or travel time from the target parking position is longer than the first predetermined length and that is a section where the own vehicle 1 traveled in the advancing direction is greater than or equal to a predetermined threshold value and, when the length of the advancing travel section is not greater than or equal to the predetermined threshold value, does not have to store the extracted target object as a learned target object.

### Advantageous Effects of Embodiments

(1) A controller 19 extracts a target object in surroundings of a target parking position from surrounding environment data acquired by detecting a surrounding environment of an own vehicle 1 using external sensors 15 and stores the extracted target object in a storage device 19b as a learned target object in conjunction with the target parking position, in advance, and parks the own vehicle 1 at the target parking position after storing the learned target object in the storage device 19b. The controller 19, when length of an advancing travel section, the advancing travel section being a section where the own vehicle 1 travels in an advancing direction, within a data detection section, the data detection section being a section where the own vehicle 1 travels and acquires the surrounding environment data, is greater than or equal to a predetermined threshold value, stores the extracted target object as a learned target object and, when length of the advancing travel section is not greater than or equal to a predetermined threshold value, does not store the extracted target object as the learned target object.

Because of this configuration, a learned target object existing along a parking route along which the own vehicle 1 travels in the advancing direction toward the target parking position 30 before the own vehicle 1 reaches a vicinity of the target parking position 30 can be stored. Thus, since at the time of identifying a relative position of the own vehicle 1 with respect to the target parking position 30 using a learned target object when parking assistance is performed, it is possible to prevent the identification of the relative position from becoming difficult, dissatisfaction of the user with inability to perform the parking assistance can be avoided.
(2) The controller 19 may: register, at a time of storing the learned target object, relative position data representing a relative positional relationship between the learned target object and the target parking position in the storage device 19b; detect, at a time of parking the own vehicle 1 to the target parking position after storing the learned target object in the storage device 19b, a position of a surrounding target object, the surrounding target object being a target object existing in surroundings of the own vehicle 1; calculate a relative positional relationship between the target parking position and a current position of the own vehicle 1, based on the relative position data and a position of the surrounding target object; calculate a travel trajectory starting from a current position of the own vehicle 1 and reaching the target parking position, based on the calculated relative positional relationship; and assist parking of the own vehicle 1 at the target parking position, based on the travel trajectory.

Because of this configuration, the user can use parking assistance control to assist parking of the own vehicle 1 at the pre-registered target parking position.
(3) The controller 19 may, when length of an advancing travel section, the advancing travel section being a section where travel distance or travel time from the target parking position is less than or equal to a first predetermined length and the own vehicle travels in an advancing direction, within the data detection section is greater than or equal to a predetermined threshold value, store the extracted target object as the learned target object and, when length of the advancing travel section is not greater than or equal to the predetermined threshold value, does not have to store the extracted target object as a learned target object. Because of this configuration, performing determination at a position close to the target parking position enables a straight travel section to be secured at the position close to the target parking position, and it is possible to prevent identification of the relative position of the own vehicle 1 with respect to the target parking position from becoming difficult at the position close to the target parking position.
(4) The controller 19 may store the target object extracted from the surrounding environment data detected in a section where travel distance or travel time from the target parking position is less than or equal to a first predetermined length within the data detection section, as the learned target object. The controller 19 may store the target object extracted from the surrounding environment data detected in a section including, as a section where travel distance or travel time from the target parking position is less than or equal to the first predetermined length, the advancing travel section and a reverse travel section, the reverse travel section being a section where the own vehicle 1 travels in a reverse direction, as the learned target object. Because of this configuration, it is possible to prevent capacity to store the learned target object from increasing.
(5) When vehicle speed of the own vehicle 1 in the data detection section exceeds a predetermined speed, the controller 19 does not have to store the learned target object. This configuration can prevent unclear learned target object data from being registered due to a surrounding image becoming unclear or reduction in self-position estimation accuracy because of high vehicle speed.
(6) A total of lengths of sections from which the target object to be stored as the learned target object is extracted among the advancing travel sections may be less than or equal to a second predetermined length. By limiting the length of the advancing travel section in this way, the matching processing between a learned target object and a surrounding target object is facilitated when the parking assist control is performed.
(7) When not storing the learned target object, the controller 19 may notify a passenger of the own vehicle 1. Because of this configuration, the inability to store a learned target object located along an appropriate route can be notified to the passenger.
(8) When a number of times that the own vehicle 1 performs maneuvering back and forth in the data detection section is greater than a predetermined number of times, the controller 19 does not have to store the learned target object. Because of this configuration, when the own vehicle 1 maneuvers back and forth repeatedly in a narrow section, it is possible to prevent a target object located along an inappropriate parking route from being stored as a learned target object.
(9) When length of a section where the surrounding environment data from which a target object able to be stored as the learned target object is to be extracted are detected within an advancing travel section where the own vehicle 1 travels in an advancing direction before performing first maneuvering back and forth in the data detection section is less than a predetermined length, the controller 19 does not have to store the learned target object. Because of this configuration, a learned target object can be stored in a sufficiently long range along a parking route along which the own vehicle 1 travels in the advancing direction to a vicinity of the target parking position.
(10) The predetermined threshold value may be set to different values between a case of right-angle parking where the own vehicle 1 is parked at a right angle with respect to a travel direction of a pathway in which the own vehicle 1 travels towards the target parking position and a case of parallel parking where the own vehicle 1 is parked in parallel with the travel direction. Because of this configuration, it is possible to set an appropriate predetermined threshold value depending on a parking type.

### REFERENCE SIGNS LIST

1 Own vehicle
10 Parking assistance device
11 Positioning device
12 Map database
13 Human-machine interface
14 Shift switch
15 External sensor
16 Vehicle sensor
17 Parking switch
19 Controller
19a Processor
19b Storage device
20 Parking brake
21a Steering actuator
21b Accelerator actuator
21c Brake actuator
50 HMI control unit
51 Parking assistance control unit
52 Image conversion unit
53 Self-position calculation unit
54 Target object detection unit
55 Map generation unit
56 Map data
57 Target parking position detection unit
59 Target trajectory generation unit
60 Steering control unit
61 Vehicle speed control unit

1. A parking assistance method for assisting parking of an own vehicle at a target parking position, the parking assistance method comprising:
extracting a target object in surroundings of the target parking position from surrounding environment data acquired by detecting a surrounding environment of the own vehicle using a sensor of the own vehicle, and storing the extracted target object in a storage device as a learned target object in conjunction with the target parking position, in advance; and
assisting, at a time of parking the own vehicle at the target parking position after storing the learned target object in the storage device, parking of the own vehicle at the target parking position, based on the learned target object,
wherein the parking assistance method, when length of an advancing travel section, the advancing travel section being a section where the own vehicle travels in an advancing direction, within a data detection section, the data detection section being a section where the own vehicle travels and acquires the surrounding environment data, is greater than or equal to a predetermined threshold value, stores the extracted target object as a learned target object and, when length of the advancing travel section is not greater than or equal to the predetermined threshold value, does not store the extracted target object as the learned target object.

2. The parking assistance method according to claim 1 comprising:
registering, at a time of storing the learned target object, relative position data representing a relative positional relationship between the learned target object and the target parking position in the storage device;
detecting, at a time of parking the own vehicle at the target parking position after storing the learned target object in the storage device, a position of a surrounding target object, the surrounding target object being a target object existing in surroundings of the own vehicle;
calculating a relative positional relationship between the target parking position and a current position of the own vehicle, based on the relative position data and a position of the surrounding target object;
calculating a travel trajectory starting from a current position of the own vehicle and reaching the target parking position, based on the calculated relative positional relationship; and
assisting parking of the own vehicle at the target parking position, based on the travel trajectory.

3. The parking assistance method according to claim 1, wherein the parking assistance method, when length of an advancing travel section, the advancing travel section being a section where travel distance or travel time from the target parking position is less than or equal to a first predetermined length and the own vehicle travels in an advancing direction, within the data detection section is greater than or equal to a predetermined threshold value, stores the extracted target object as the learned target object and, when length of the advancing travel section is not greater than or equal to the predetermined threshold value, does not store the extracted target object as a learned target object.

4. The parking assistance method according to claim 1, wherein the parking assistance method stores the target object extracted from the surrounding environment data detected in a section where travel distance or travel time from the target parking position is less than or equal to a first predetermined length within the data detection section as the learned target object.

5. The parking assistance method according to claim 3, wherein the parking assistance method stores the target object extracted from the surrounding environment data detected in a section including, as a section where travel distance or travel time from the target parking position is less than or equal to the first predetermined length, the advancing travel section and a reverse travel section, the reverse travel section being a section where the own vehicle travels in a reverse direction, as the learned target object.

6. The parking assistance method according to claim 1, wherein when vehicle speed of the own vehicle in the data detection section exceeds a predetermined speed, the parking assistance method does not store the learned target object.

7. The parking assistance method according to claim 1, wherein a total of lengths of sections from which the target object to be stored as the learned target object is extracted among the advancing travel sections is less than or equal to a second predetermined length.

8. The parking assistance method according to claim 1, wherein when not storing the learned target object, the parking assistance method notifies a passenger of the own vehicle.

9. The parking assistance method according to claim 1, wherein when a number of times that the own vehicle performs maneuvering back and forth in the data detection section is greater than a predetermined number of times, the parking assistance method does not store the learned target object.

10. The parking assistance method according to claim 1, wherein when length of a section where the surrounding environment data from which a target object able to be stored as the learned target object is to be extracted are acquired within an advancing travel section where the own vehicle travels in an advancing direction before performing first maneuvering back and forth in the data detection section is less than a predetermined length, the parking assistance method does not store the learned target object.

11. The parking assistance method according to claim 1, wherein the parking assistance method sets the predetermined threshold value to different values between a case of right-angle parking where the own vehicle is parked at a right angle with respect to a travel direction of a pathway in which the own vehicle travels towards the target parking position and a case of parallel parking where the own vehicle is parked in parallel with the travel direction.

12. A parking assistance device configured to assist parking of an own vehicle at a target parking position, the parking assistance device comprising:
a sensor configured to detect a surrounding environment of the own vehicle;
a storage device; and
a controller configured to extract a target object in surroundings of the target parking position from surrounding environment data acquired by detecting a surrounding environment of the own vehicle using the sensor and store the extracted target object in a storage device as a learned target object in conjunction with the target parking position, in advance, and assist, at a time of parking the own vehicle at the target parking position after storing the learned target object in the storage device, parking of the own vehicle at the target parking position, based on the learned target object,
wherein the controller, when length of an advancing travel section, the advancing travel section being a section where the own vehicle travels in an advancing direction, within a data detection section, the data detection section being a section where the own vehicle travels and acquires the surrounding environment data, is greater than or equal to a predetermined threshold value, stores the extracted target object as a learned target object and, when length of the advancing travel section is not greater than or equal to a predetermined threshold value, does not store the extracted target object as the learned target object.
